(19) United States
(12) Patent Application Publication
(10) Pub. No.: US 2008/0155309 A1
(43) Pub. Date: Jun. 26, 2008

(54) Memory card and debugging method employed by the same

(76) Inventors: Jae-wook Cheong, Gangdong-gu (KR); Young-gon Kim, Suwon-si (KR); Kil-joong Yun, Yongin-si (KR)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/607,023

(22) Filed: Dec. 1, 2006

(30) Foreign Application Priority Data
Oct. 26, 2006 (KR) 10-2006-0104680

(51) Int. Cl. G06F 11/00

(52) U.S. Cl. 714/5

(57) ABSTRACT

A debugging method employed by a memory card includes performing an initialization operation of the memory card, determining whether an error has occurred in the initialization operation, and upon the occurrence of an error during the initialization operation, executing an error control program when a first control command is input. The execution of the error control program performing an interrupt service routine, and jumping to a system initialization routine after the interrupt service routine is performed.

### BACKGROUND OF THE INVENTION

1. Field of the Invention

The present invention generally relates to memory cards, and more particularly, the present invention relates to a method of debugging a memory card, and to a memory card which executes a debugging method.

A claim of priority is made to Korean Patent Application No. 10-2006-0104680, filed 26 Oct. 2006, in the Korean Intellectual Property Office, the disclosure of which is incorporated herein in its entirety by reference.

2. Description of the Related Art

Certain types of conventional memory cards (e.g., moviNAND, SD/MMC, and others) include both a central processing unit and a memory unit. Typically, the memory unit is configured from flash memory. The memory cards are capable of executing application programs to record, read, and erase data in response to commands from an external or remote host device.

The memory unit of the memory card may be configured of a plurality of flash memory cores that are stacked to form a recording medium. and in conventional memory cards, a conventional memory unit chip is separated from a controller. However, since multi-chip packages have recently become more lightweight and smaller, the memory units have become embodied in the form of a plurality of memory cores at a wafer level. The memory cards can include one or more pads in order to be interface with an external host. The number of pads included in the memory cards is reduced due to a physical size thereof.

The structure of a conventional memory card will be described with reference to FIG. 1.

FIG. 1 is a block diagram of a conventional memory card 10 that is operatively connected to a host device 20. Referring to FIG. 1, the memory card 10 includes a NAND flash memory 11, a controller 13 for driving the NAND flash memory 11, a host interface 12 for transmitting a command CMD, data DATA, a clock signal CLK, and the like, with the host device 20, and a memory interface 14 for communicating between the NAND flash memory 11 and the controller 13.

The NAND flash memory 11 communicates the command CMD or the data DATA between the host device 20 via the controller 13 of the memory card 10.

In a conventional memory card having a NAND flash memory only, a pad that connected to the memory unit is included in the memory card so that the NAND flash memory can be directly externally accessed through the pad. That is, direct external access to the NAND flash memory 11 is possible. However, the multi-chip package shown in FIG. 1 does not include a pad for directly externally connecting to the NAND flash memory 11. Therefore, direct external access to the NAND flash memory 11 not impossible.

When a memory card is operated, a system can become inoperable, e.g., a routing loop or the like may occur, during the execution of an application program due to a systematic factor or a defect of the memory unit. When the memory unit is stacked at wafer level in the memory card 10, the defect of the memory unit can be increased. However, it is not possible to directly externally access the memory unit or test the memory unit in the memory card 10 in which the memory unit is connected to the controller 13. Debugging is timely and costly, and requires a decapsulation process of the memory card 10 and a subsequent memory dump.

### SUMMARY OF THE INVENTION

According to an aspect of the present invention, a debugging method employed by a memory card is provided. The debugging method includes performing an initialization operation of the memory card, determining whether an error has occurred in the initialization operation, and upon the occurrence of an error during the initialization operation, executing an error control program when a first control command is input. The execution of the error control program performing an interrupt service routine, and jumping to a system initialization routine after the interrupt service routine is performed.

According to another aspect of the present invention, a debugging method employed by a memory card is provided. The debugging method includes performing an initialization operation of the memory card, performing an application program corresponding to a code address of a program read-only memory according to a command provided from a host device operatively connected to the memory card, determining whether an error has occurred in the application program, and upon the occurrence of an error during the application program, executing an error control program when a control command is input. The executing of the error control program includes storing a code address of a program being executed when the error occurs, and initializing a system using an interrupt service routine.

According to an aspect of the present invention, a memory card is provided which includes a memory unit including one or more memory blocks, a memory controller which generates a control signal for operating the memory unit, a program read-only-memory which stores one or more application programs and an error control program, and a central processing unit which controls systems included in the memory card. The memory card is configured to execute an initialization program, and when an error occurs during execution of the initialization program, the memory card is configured to execute the error control program according to a first control command, to execute an interrupt service routine according to the error control program, and to execute a system initialization routine after the interrupt service routine is performed.

### BRIEF DESCRIPTION OF THE DRAWINGS

The above and other features and advantages of the present invention will become readily apparent from the detailed description that follows, with reference to the accompanying drawings, in which:

FIG. 1 is a block diagram of the structure of a conventional memory card;

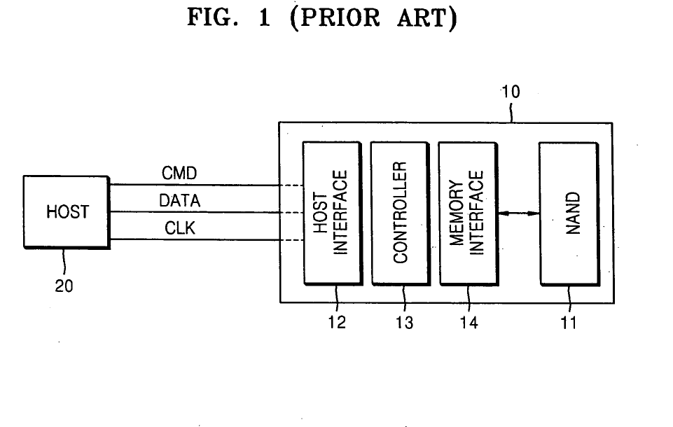

FIG. 2 is a block diagram of the structure of a memory card according to an embodiment of the present invention;

FIG. 3 is a block diagram of a central processing unit (CPU) and program read-only memory (ROM) illustrated in FIG. 2; and

FIG. 4 is a flowchart illustrating a debugging method employed by a memory card according to an embodiment of the present invention.

### DETAILED DESCRIPTION OF EMBODIMENTS

The present invention will now be described more fully with reference to the accompanying drawings, in which exemplary and non-limiting embodiments of the invention are shown.

The invention may be embodied in many different forms and should not be construed as being limited to the embodiments set forth herein. Rather, these embodiments are provided so that this disclosure will be thorough and complete, and will fully convey the concept of the invention to those skilled in the art. Like reference numerals in the drawings denote like elements.

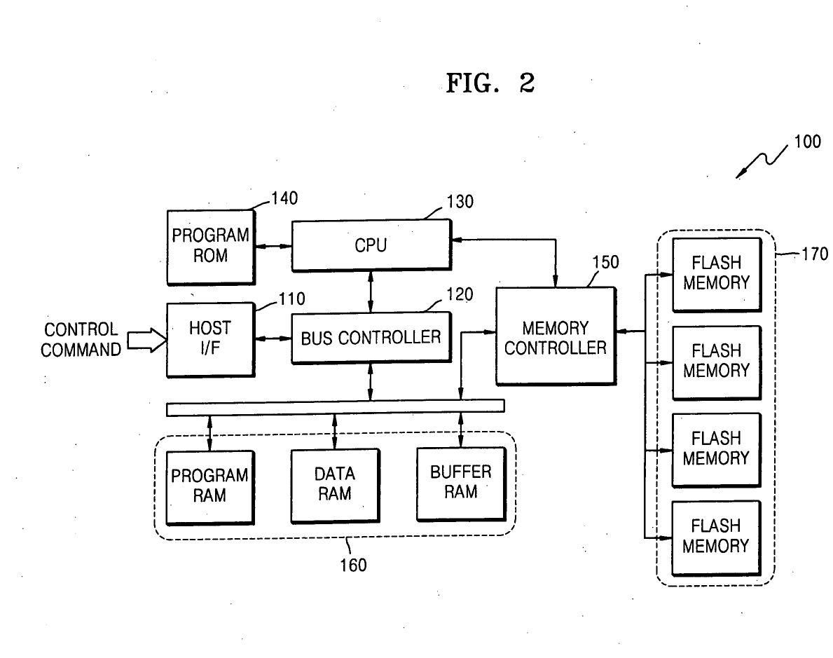

FIG. 2 is a block diagram of a memory card 100 according to an embodiment of the present invention.

Referring to FIG. 2, the memory card 100 includes a host interface (I/F) 110 for interfacing with an external host (not shown), a bus controller 120, a central processing unit (CPU) 130 for controlling systems included in the memory card 100, and a program read-only memory (ROM) 140 in which an initialization program, and one or more application programs are stored.

The memory card 100 further includes a memory controller 150 that generates a control signal for controlling a memory unit included in the memory card 100 under control of the CPU 130.

The memory card 100 still further includes random access memories (RAMs) 160 for temporally storing, for example, one or more programs and data that are necessary for operating the memory unit. In this example, the RAMs 160 include a program RAM, a data RAM, and a buffer RAM. For example, in operation, a program that is read from the program ROM 140 is copied to the program RAM, and the program is then read from the program RAM to execute the program.

The memory card 100 further includes the afore-mentioned memory unit. In the example of FIG. 2, the memory unit is a flash memory unit 170 which includes one or more flash memory blocks.

If an error occurs when the memory card 100 employed, for example, in a digital camera or an MP3 player is operated, there is conventionally no way to analyze a cause of the occurrence of the error except by performing a decapsulation process even if the memory card 100 is separated from a board. In the present invention, the cause of the occurrence of the error may be analyzed by providing a specific command to the memory card 100 on the board, and checking an internal status of the memory card 100.

A method of performing a debugging operation using the memory card 100 illustrated in FIG. 2 will now be described.

When a power source is applied to the memory card 100, the memory card 100 examines hardware included therein, and performs an initialization process such as loading of an operating system (OS). The initialization process may not be normally performed due to a systematic factor or a factor of the flash memory unit 170 when data necessary for performing the initialization process is read from the flash memory unit 170. In this case, the initialization process stops and a routing loop occurs, and thus no further code progress is made.

To analyze such an error by dumping content stored in the flash memory unit 170, a specific control command is provided to the memory card 100 via the host interface 110. The CPU 130 decodes the control command, and extracts a code address for reading a program recorded in the program ROM 140 from the control command. An error control program corresponding to the code address extracted from the control command is read from the program ROM 140 and is performed.

If an error occurs when the initialization operation of the memory card 100 is performed or an application program is executed, the specific control command can be provided by an examiner that perform debugging to determine the cause of the occurrence of the error. The error control program is coded and recorded in the program ROM 140 in order to free the memory card 100 from the systematic error and allow the memory card 100 to perform debugging via a memory dumping. A system is branched to an error control program area according to the code address extracted from the specific control command.

The error control program comprises a code in which an interrupt service routine program is executed according to the specific control command. According to a conventional interrupt service routine, an application program designated by a user is performed when an interrupt occurs and then the system is returned to a program that was previously running. However, the interrupt service routine according to the specific control command in the present embodiment stops executing a current program in which an error occurs, and branches to a command waiting routine for performing debugging of the memory card 100.

A code address corresponding to the program currently executing when the specific control command is input is temporally stored. Although not shown, the code address can be stored in any memory capable of storing data, e.g., a register included in the CPU 130. The code address can be used as information on the program in which the error of the memory card 100 occurs when debugging is performed.

According to the error control program, the interrupt service routine program is executed and then the system is jumped to a system initialization routine. A temporal initialization operation of the memory card 100 is performed in the system initialization routine. The temporal initialization operation of system portions of the memory card 100 excluding the flash memory unit 170 is performed.

After the temporal initialization operation of the memory card 100 is performed in the system initialization routine, the system is branched to a command waiting routine. The code address temporally stored in the command waiting routine is read, and a predetermined command for performing debugging of the memory card 100 is provided to the memory card 100. That is, the stored code address is read to understand information on the program in which the error occurs. A command for dumping the content of the flash memory unit 170 is provided to the memory card 100. The information on the occurrence of the error and a result of dumping the content of the flash memory unit 170 can be used to perform debugging of the memory card 100.

According to the present embodiment, debugging takes place when an error occurs when the initialization operation of the memory card 100 is performed. However, the present invention is not limited thereto. For example, when the initialization operation is normally performed, the memory card 100 executes various application programs according to an input command. When an area invasion or a routing loop occurs during the execution of application programs, and no further code progress is made, the debugging process of the present embodiment can be executed.

That is, when an error occurs during the execution of an application program, a specific control command is applied to the memory card 100. As described above, the error control program can be coded so that the control command provided when the error occurs during the initialization of the memory card 100 and the specific control command provided when the error occurs during the execution of the application program can be identical to each other. Also, the error control program can be coded so that the two control commands can be different from each other.

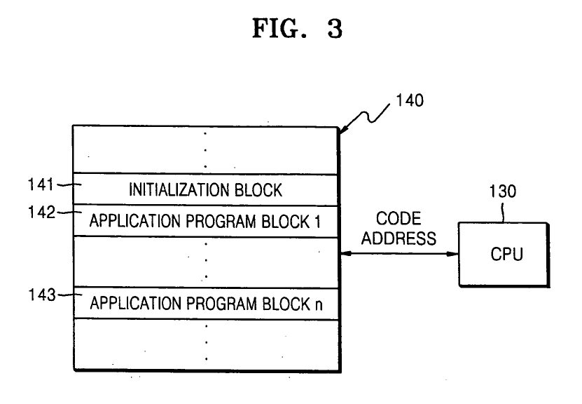

FIG. 3 is a block diagram of the CPU 130 and memory blocks of the program ROM 140 illustrated in FIG. 2. Referring to FIG. 3, the program ROM 140 included in the memory card 100 includes an initialization block 141 which contains code for performing the initialization operation of the memory card 100, and application program blocks 1 through n 141˜143 which contain code for performing various application programs.

In operation, the CPU 130 extracts a code address from a command provided from the host device, copies a code recorded in an area of the ROM 140 corresponding to the code address to a program RAM, and performs a program corresponding to the code. For example, an error control program for debugging the memory card 100 can be recorded in the n^{th} application program block 143. A specific control command includes information on a code address of the application program block 143 in which the error control program is recorded.

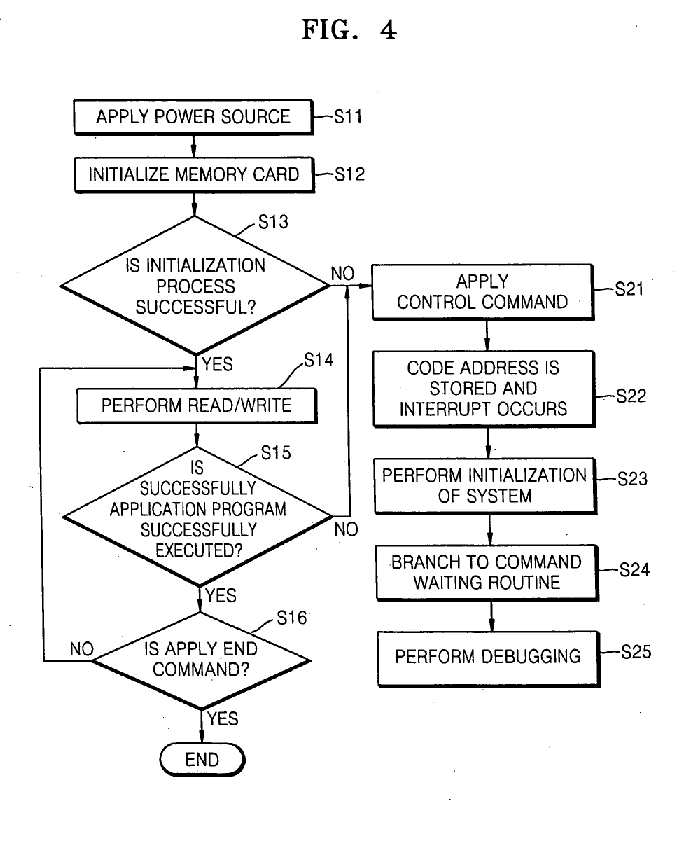

A debugging method using a memory card according to an embodiment of the present invention will now be described with reference to FIG. 4.

FIG. 4 is a flowchart for describing a debugging method of a memory card according to an embodiment of the present invention. Referring to FIG. 4, a power source is applied to the memory card (s11), and then, hardware included in the memory card is examined and an initialization process, e.g., loading of an operating system (OS), is performed (s12).

A determination is then made as to whether the initialization process was normally executed (s13).

When the initialization process has been normally executed, an application program, e.g., a reading/recording operation of a memory unit, is executed in response to various commands from a host (s14).

On the other hand, when an error occurs during the initialization process as a result of a systematic factor or a factor of the flash memory unit, a specific control command for overcoming system inoperability and performing debugging of the memory card is applied (s21). The control command may be provided in any of a variety of different manners. For example, the control command can be provided manually by a user during a process of testing the memory card.

If the control command is applied, a code address of a program which is being currently executed is stored. An error control program recorded in the program ROM is read according to information on the code address included in the control command. When the error control program is executed, an interrupt occurs (s22).

After the interrupt occurs, the system is jumped to a system initialization routine, and thus a system initialization operation of the memory card is performed (s23). The system initialization operation of the system other than a memory unit is performed for a debugging operation of the memory card. The system is branched to a command waiting routine in order to receive commands for the debugging operation, e.g., reading of the stored code address, (s24). In the command waiting routine, the stored code address is read, information on a program in which an error occurs is analyzed, and cell content of the memory unit is dumped to perform debugging (s25).

When the initialization process is normally performed and the application program, e.g., a reading/recording operation of the memory unit, is executed, a determination is made as to whether the application program is normally executed (s15). When the application program is normally executed, a next application programs are performed. Steps s15 and s16 are repeated until an end command is applied (s16).

When the system is inoperable due to an error that occurs during the execution of the application program, a control command for executing the error control program is applied. As described above, the control command can be identical to or different from the control command provided when the error occurs during the initialization process of the memory card.

If the control command is applied due to an error which occurred when the application program was executed, a code address corresponding to the application program is stored, and an interrupt service routine is executed. The system initialization process and a command waiting routine are performed. In the command waiting routine, debugging is performed using the code address corresponding to the application program in which the error occurs, and a result of dumping cell content of the memory unit.

A memory card and a debugging method employed by the same according to embodiments of the present invention allow for debugging of an error that occurs during an initialization process or when an application program is executed using an interrupt service routine. Debugging is possible without decapsulation of the memory card, thus reducing costs and time expenditures.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A debugging method employed by a memory card, said method comprising:
performing an initialization operation of the memory card;
determining whether an error has occurred in the initialization operation; and
upon the occurrence of an error during the initialization operation, executing an error control program when a first control command is input,
wherein the executing of the error control program comprises:
performing an interrupt service routine; and
jumping to a system initialization routine after the interrupt service routine is performed.

2. The method of claim 1, wherein the executing of the error control program further comprises branching to a command waiting routine after a system initialization process is performed.

3. The method of claim 2, further comprising, after branching to the command waiting routine, performing a debugging operation using information regarding the occurrence of the error and a result of dumping content of a memory unit of the memory card.

4. The method of claim 3, wherein the information on the occurrence of the error is a code address of a program being executed when the error occurs.

5. The method of claim 1, further comprising storing a code address of a program being executed when the error occurs.

6. The method of claim 1, wherein the system initialization routine performs a temporal initialization operation of systems other than a memory unit of the memory card.

7. The method of claim 1, further comprising, after the determining whether an error has not occurred in the initialization operation,
executing an application program according to an input command;
determining if an error has occurred when the application program is executed; and
when an error occurs when the application program is executed, executing the error control program when a second control command is input.

8. The method of claim 7, wherein the first control command and the second control command are the same control command input by a host device operatively coupled to the memory card.

9. The method of claim 7, wherein the first control command and the second control command are different control commands input by a host device operatively coupled to the memory card, and the error control program is executed according to the first control command and the second control command.

10. A debugging method employed by a memory card comprising:
performing an initialization operation of the memory card;
performing an application program corresponding to a code address of a program read-only memory according to a command provided from a host device operatively connected to the memory card;
determining whether an error has occurred in the application program; and
upon the occurrence of an error during the application program, executing an error control program when a control command is input,
wherein the executing of the error control program comprises:
storing a code address of a program being executed when the error occurs; and
initializing a system using an interrupt service routine.

11. The method of claim 10, wherein the executing of the error control program further comprises branching to a command waiting routine after the system is initialized.

12. The method of claim 11 further comprising after branching to the command waiting routine, performing debugging using the stored code address and a result of dumping content of a memory unit of the memory card.

13. The method of claim 10, wherein when it is determined that an error has not occurred in the application program, the method further comprises, until an end command is applied, determining whether an error has occurred in each subsequently executed application program, and upon the occurrence of an error during a subsequently executed application program, executing the error control program when a control command is input.

14. A memory card comprising:
a memory unit comprising one or more memory blocks;
a memory controller which generates a control signal for operating the memory unit;
a program read-only-memory which stores one or more application programs and an error control program; and
a central processing unit which controls systems included in the memory card,
wherein the memory card is configured to execute an initialization program, and when an error occurs during execution of the initialization program, the memory card is configured to execute the error control program according to a first control command, to execute an interrupt service routine according to the error control program, and to execute a system initialization routine after the interrupt service routine is performed.

15. The memory card of claim 14, wherein the error control program is programmed so that a command waiting routine is performed after the system initialization routine is performed.

16. The memory card of claim 15, wherein the CPU stores a code address of a program being executed when the error occurs.

17. The memory card of claim 16, wherein debugging is performed using the stored code address and a result of dumping content of one or more memory blocks of the memory unit when the command waiting routine is performed.

18. The memory card of claim 14, wherein, when a error does not occur during execution of the initialization program, the memory card is configured to execute the error control program according to a second control command when an error occurs during execution an application program corresponding to an input command.

19. The memory card of claim 18, wherein the first control command and the second control command are the same control command input by a host device operatively connected to the memory card.

20. The memory card of claim 18, wherein the first control command and the second control command are different control commands input by a host device operatively connected to the memory card, and the error control program is executed according to the first control command and the second control command.
